(19) United States
(12) Patent Application Publication
(10) Pub. No.: US 2019/0261575 A1
(43) Pub. Date: Aug. 29, 2019

(54) LIGHT FIXTURE

(71) Applicant: OBSCHESTVO S OGRANICHENNOI OTVETSTVENNOSTYU «ZELENAYA LABORATORIYA», Yakutsk (RU)

(72) Inventors: Liudmila Leonidovna POPOVA, Yakutsk (RU); Yury Nikolaevich KULCHIN, Vladivostok (RU); Evgenii Petrovich SUBBOTIN, Vladivostok (RU); Mikhail Ivanovich ZVONAREV, Vladivostok (RU)

(73) Assignee: OBSCHESTVO S OGRANICHENNOI OTVETSTVENNOSTYU «ZELENAYA LABORATORIYA», Yakutsk (RU)

(21) Appl. No.: 16/345,746

(22) PCT Filed: May 17, 2017
(86) PCT No.: PCT/RU2017/000319

§ 371 Date: Apr. 29, 2019

(30) Foreign Application Priority Data
Jan. 20, 2017 (RU) 2017101917

(51) Int. Cl. A01G 7/04

(52) U.S. Cl. CPC A01G 7/045

(57) ABSTRACT

A light fixture comprising a set of known LEDs which have different emission spectra in a range of the order of 400-800 nm and are equipped with drivers, is characterized in that from the known LEDs having different spectra, LEDs are selected which have emission spectra in a range of 443-650 nm, wherein the spectra of the selected LEDs overlap one another at different spectral sections of the range, preferably at a level of 0.5 of the maximum amplitude, wherein 5 types of LEDs each having a power of 10 W in the preferred embodiment are used, including warm white, dark blue, light blue, green and full spectrum, wherein the drivers of the LEDs are capable of feeding energy thereto that amounts to 1.4, 0.3, 0.3, and 1.25, respectively, of the level of energy supplied to the full-spectrum LED. The invention provides a light fixture with an emission spectrum corresponding to sunlight while minimizing the total number of LEDs used.

### FIELD OF THE INVENTION

The invention relates to lighting devices that provide lighting, which as much as possible corresponds to the spectrum of sunlight using light-emitting diodes.

### BACKGROUND

There is a known light fixture that contains a set of Light Emitting Diodes (LEDs) with different emission spectra, supplied with drivers. In this case, the light fixture contains twelve red LEDs with a wavelength of 660 nm, six orange LEDs with a wavelength of 612 nm, and one blue LED with a wavelength of 470 nm (see U.S. Pat. No. 6,921,182).

Also known light fixture that contains a set of known LEDs with different emission spectra, lying in the range of about 400-800 nm, equipped with drivers (see RU No. 2504143, 2014). At the same time, at least two types of LEDs are used in the light fixture. Moreover, it is preferable that the first type LEDs emit in the blue range with a wavelength of 400 nm to 500 nm, and the second type LEDs emit in red with a wavelength of 600 nm to 700 nm. The light emitted by the first group of LEDs consists of approximately 80%-90% red light and 10%-20% blue light.

All of these solutions were aimed at obtaining the optimal combination of wavelengths to enhance the growth rate of plants, as well as reducing energy consumption and increasing service life, with technical implementation compared to existing light-growing technologies, but do not provide a radiation spectrum close to the spectrum of the sun. In addition, combinations of wavelengths chosen to enhance plant growth were unattractive for people observing an illuminated plant. The latter is because the total spectrum of such a light source has a highly uneven (wavy) character.

### SUMMARY OF THE INVENTION

The task for which the invention is directed is to provide a light fixture with a spectrum of radiation that has close similarity to a natural sunlight.

The technical result is expressed in providing the light fixture with a spectrum of radiation close to the spectrum of the sun, while minimizing the total number of LEDs used.

To solve this task, a light fixture was taken that comprises a set of five Light Emitting Diodes (LEDs) having different emission spectra in a range of 443-650 nm, wherein said LEDs are equipped with drivers, wherein the spectra of said LEDs overlap one another at different spectral sections of the range, preferably at a level of 0.5 of the maximum amplitude, wherein said five types of LEDs include warm white, dark blue, light blue, green and full spectrum emissions, wherein the drivers of the warm white, dark blue, light blue, green LEDs are capable of feeding energy thereto that amounts to 1.4, 0.3, 0.3, and 1.25, respectively, of the level of energy supplied to the full-spectrum LED.

Comparative analysis of the features of the claimed solution with the features of the prototype and analogs indicates the compliance of the stated solution to the criterion of “novelty.”

The set of features of the distinctive part of the claims provides a light fixture with a radiation spectrum corresponding to sunlight, and the distinguishing features of the distinctive part of the claims provide a solution to the following set of functional tasks.

The features “from known light emitting diodes with different spectra select light emitting diodes whose emission spectrum is in the range of 443-650 nm” provide the fullest approximation to the spectrum of sunlight, with a minimum number of used types of LEDs.

The features “spectra constituting a set of selected LEDs overlap each other in different spectral regions of the range” contribute to the alignment (reduction of waviness) of the total spectrum of the light fixture.

Features indicating that the spectra constituting the set of selected LEDs overlap “preferably at 0.5 of the maximum amplitude” also contribute to reducing the waviness of the total spectrum of the light fixture.

Features indicating “5 types of LEDs are used each, including warm white, dark blue, light blue; green and full spectrum” ensure that the light fixture forms a radiation spectrum close to sunlight.

Features indicating that “the drivers of the LEDs are capable of feeding energy thereto that amounts to 1.4, 0.3, 0.3, and 1.25, respectively, of the level of energy supplied to the full-spectrum LED” ensure a proper distribution of the components.

### BRIEF DESCRIPTION OF THE DRAWINGS

FIG. 1 shows the emission spectra of the LEDs used in the composition of the light fixture;

FIG. 2 shows the spectrum of the total radiation of all five LEDs of the light fixture, without adjustment of the energy level supplied to them;

FIG. 3 shows the total spectrum of the LEDs of the light fixture, brought into proximity with the solar radiation in the first approximation;

FIG. 4 shows the final emission spectrum of the light fixture that is highly similar to the spectrum of solar radiation.

### DETAILED DESCRIPTION OF THE INVENTION

Currently, the industry produces various LEDs with a narrow and wide emission band, with a peak of radiation falling on one or several specific frequencies of light.

A wide frequency range of light from UV to far red and infrared light is covered. In addition, there are white LEDs with different color temperatures.

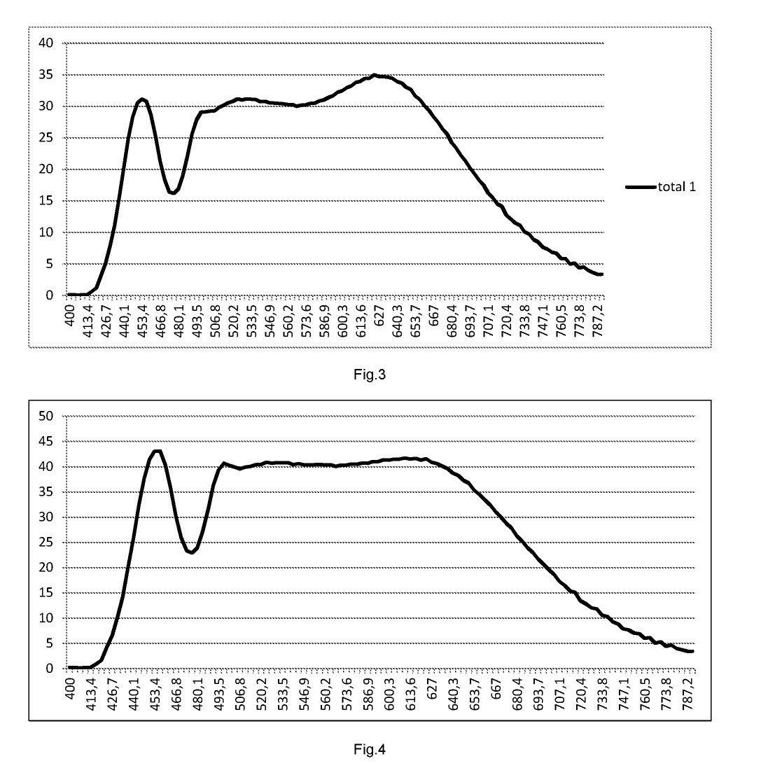

The idea behind the present invention is the following: there is a set of LEDs with different spectra. Of these, one can make a ensemble of LEDs with overlapping spectral curves at a level of about 0.4-0.6, and then, summing up their energy parameters, they can form a spectrum corresponding to sunlight (see FIG. 3-4).

Thus, if a simulated range of the spectrum of solar radiation is known, then by choosing different LEDs with different spectra and different intensities, one can get a light source that is very similar in its spectrum to solar radiation.

In order for the light emission spectrum of the resulting light fixture not to have a wave-like character, but to be even, it is necessary that the spectra of the individual LEDs be approximately the same shape (width) and intersect with each other at 0.5 of the maximum.

If, for example, at a wavelength of 500 nm there are two LEDs emitting a maximum at 500 nm, and at 0.5 the bandwidth of the first one is 50 nm, and the second one is 150 nm, then when added to other LEDs, unevenness will appear (wave-like character leads to the difference of the received spectrum from the spectrum of the sun), although on average the energy will be the same.

The simulated range of 443-650 nm from photosynthetically active radiation from the solar spectrum, 400-800 nm, is realized by a set of five types of 10 W LEDs of the following composition: WW—warm white, GR—green, DB—dark blue, LB—light blue and FS—full spectrum (see. FIG. 1).

In this case, these LEDs overlap each other in different spectral regions of the simulated range, preferably at a level of 0.5 of the maximum amplitude. For each type of LEDs, spectral and energy parameters were taken, which made it possible to form the first approximation of the radiation of the light fixture to the solar spectrum.

It is seen from Tab.1 that two LEDs have two radiation peaks: Warm White—at a wavelength of 447 nm (maximum irradiance is 9.3 mW/m2), and at a wavelength of 586 nm-20.7 mW/m2; at the second light-emitting diode FS at a wavelength of 443 nm-8.2 m W/m2, and at a wavelength of 650 nm-22.1 mW/m2.

TABLE 1
Parameters of LEDs modeling the range of 443-650 nm
solar spectrum

| | | Maximum irradiance (mW/m2) at the |
|---|---|---|
| | | corresponding wavelength in the |
| Color | Wavelength (nm) | wavelength band of 3.4 nm |
| Warm | 447 and 586 | 9.3 + 20.7 |
| White | | |
| Dark blue | 456 | 93.9 |
| Light blue | 493 | 78.4 |
| Green | 523 | 20.1 |
| FS | 443 and 650 | 8.2 + 22.1 |

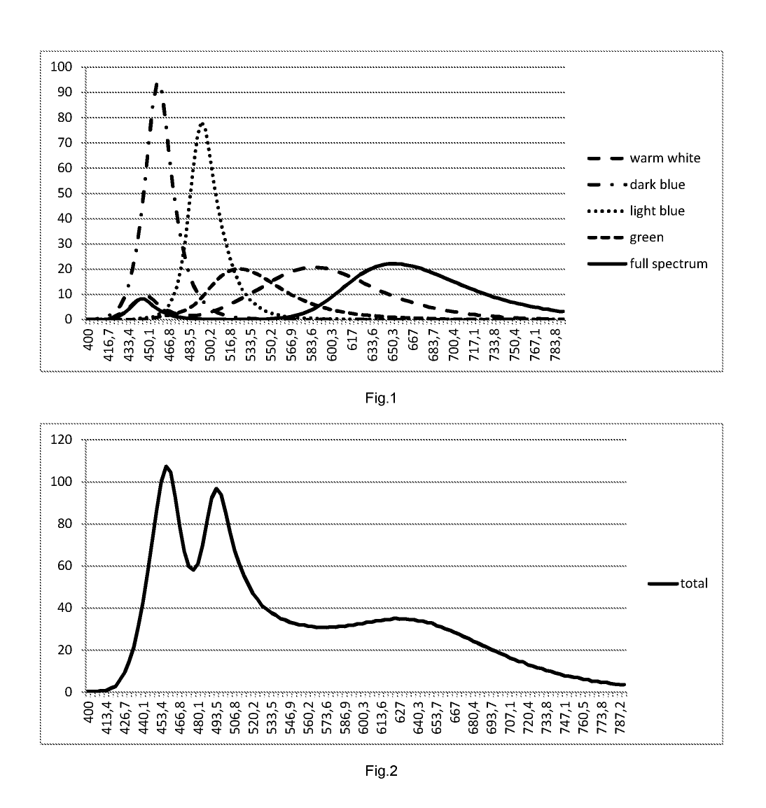

Measurements of the spectrum of LEDs (FIG. 2) showed that the Warm White, Green and FS LEDs have almost identical maxima and their spectra intersect with each other at approximately the same level of about 0.65-0.7.

The difference is only 10%. The peak values of the Dark blue and Light blue LEDs are higher than those almost 4-5 times.

The measurements were carried out with a TKA-Spectr spectrophotometer, at a distance of 500 mm from the center of the set of LEDs along their axis. In this case, the PAR of irradiation in the range of 400-800 nm was Ee (PAR)=6.66 W/m2.

If one can simply add up the emission spectra of all the LEDs without changing the amplitude or the energy supplied to the LED, one will get the total spectrum shown in FIG. 2.

It can be seen that in the blue region of the spectrum from 420 to 530 nm, the level of radiated power must be reduced. If the Dark blue and Light blue LEDs apply approximately five times less energy, they will emit five times weaker and the total spectrum will be more close to the solar one (FIG. 3).

If we take and apply energy for each LED through their drivers with the coefficients given in Table 2, the radiation spectrum shown in FIG. 4 will be obtained.

TABLE 2

| | Wavelength | |
|---|---|---|
| Color | (nm) | Coefficient |
| Warm | 447 + 586 | 1.4 |
| White | | |
| Dark blue | 456 | 0.3 |
| Light blue | 493 | 0.3 |
| Green | 523 | 1.25 |
| FS | 443 + 650 | 1 |

For the selection of acceptable radiation power in the first approximation (FIG. 3) three lines were formed with separate current drivers:
power supply from driver with 900 mA WW current—1 pc.; GR—1 pc.; FS—1 pc.
power supply from driver with 500 mA Dark blue current—1 pc.
power supply from driver 330 mA Light blue—1 pc.

All the LEDs in each line were connected in series, so the voltage at the ends of the first line was 33.2 V; at the ends of the second line −3.3 V; at the ends of the third line −2.6 V. Accordingly, the power consumption was equal to 29.88 W; 1.65 watts and 0.858 watts. The total power consumption was 32.388 watts.

For the selection of the acceptable radiation power of the resulting spectrum (FIG. 4), four lines were formed with separate current drivers:
power supply from a driver with a current of 1000 mA WW—1 pc.;
powered by a driver with a current of 890 mA GR—1 pc.;
power supply from a driver with a current of 710 mA FS—1 pc.;
power supply from the driver with 210 mA Dark blue current—1 pc., Light blue—1 pc.

1. A light fixture comprising a set of five Light Emitting Diodes (LEDs) having different emission spectra in a range of 443-650 nm, wherein said LEDs are equipped with drivers, wherein the spectra of said LEDs overlap one another at different spectral sections of the range, preferably at a level of 0.5 of the maximum amplitude, wherein said five types of LEDs include warm white, dark blue, light blue, green and full spectrum emissions, wherein the drivers of the warm white, dark blue, light blue, green LEDs are capable of feeding energy thereto that amounts to 1.4, 0.3, 0.3, and 1.25, respectively, of the level of energy supplied to the full-spectrum LED.
